(19) United States
(12) Patent Application Publication
(10) Pub. No.: US 2016/0104551 A1
(43) Pub. Date: Apr. 14, 2016

(54) YTTRIA BASED CONDUCTIVE PLASMA-RESISTANT MEMBER AND METHODS THEREOF

(71) Applicant: KOREA INSTITUTE OF MACHINERY & MATERIALS, Daejeon (KR)

(72) Inventors: Hai Doo KIM, Changwon (KR); Jae Wook LEE, Seoul (KR); Ha Neul KIM, Pohang (KR); Jin Myung KIM, Changwon (KR); Young Jo PARK, Changwon (KR); Jae Woong KO, Changwon (KR)

(21) Appl. No.: 14/879,789

(22) Filed: Oct. 9, 2015

(30) Foreign Application Priority Data
Oct. 10, 2014 (KR) 10-2014-0136865

(51) Int. Cl. H01B 1/16; C04B 35/56

(52) U.S. Cl. CPC H01B 1/16; C04B 35/5611; C04B 35/5622

(57) ABSTRACT

The present invention discloses a conductive plasma-resistant member including an yttrium oxide. The plasma-resistant member of the present invention includes an yttrium compound which includes a matrix phase consisting of yttrium oxides, and a conductive dispersed phase. According to the present invention, the present invention provides a semiconductor-grade yttria composite which may be used as a plasma-resistant member requiring conductivity like a focus ring.

### TECHNICAL FIELD

The present invention relates to a plasma-resistant component used in the semiconductor and display industries, more specifically to a conductive plasma-resistant member.

### BACKGROUND ART

Yttria (Y₂O₃) has excellent plasma-resistance and is adopted as the core material of the inner jig of high added-value processing equipment used in the semiconductor and display industries, etc.

Meanwhile, among various plasma-resistant components within the processing equipment, some components such as a focus ring, etc. prefer to be made of materials having a conductivity similar to silicon wafers because uniform plasmas are formed around the silicon wafers to improve plasma etching performance.

Generally, monolithic yttria is known as a complete non-conductive ceramic.

However, it is found that when sintering yttria, some divalent oxides are advantageous for improving densification and conductivity, and among them, CaO is known to be the most effective one.

Meanwhile, upon measuring the high-temperature conductivity for yttria added with 0˜10 mol % of CaO sintered under atmospheric pressure, the conductivity is measured to be 10⁻⁴ S/cm at 1000° C. There is no measurement result made at room temperature, but when estimating the measurement by extrapolation from the high-temperature measured value, the conductivity is expected to be greatly reduced.

In the case of hot press sintering adding various types of carbon-based materials, it is reported that the conductivity is measured to be up to 10⁻² S/cm at room temperature.

However, since carbon-based additives have a weak binding with an yttria matrix phase, they act as defects and thus would have a reduced strength compared to monolith yttria. Furthermore, due to the weak binding between the yttria matrix phase and carbon-based additives, the sintering itself may not be possible with atmospheric pressure sintering alone, which is not a severe condition like hot press sintering.

### PRIOR ARTS

### Non-Patent Documents

(1) K. Katayama et al., J. Mater. Sci., 25 (1990) pp 1503-1508
(2) K. Katayama et al., J. Euro. Ceram. Sci., 6 (1990) pp 39-45

### SUMMARY

In order to solve the problems of the prior art, the present invention aims to provide an yttria-based plasma-resistant member with chemical stability preventing etching under a fluorinated plasma atmosphere and conductivity at room temperature.

Additionally, the present invention aims to provide a method of producing a plasma-resistant member with a high strength and relative density.

In order to achieve the technical tasks above, the present invention provides a plasma-resistant member including an yttrium compound, which includes a matrix phase consisting of yttrium oxides, and a conductive dispersed phase.

According to an embodiment of the present invention, the conductive dispersed phase may include a carbide or nitride of at least one metal selected from a group consisting of Ti, Zr and Hf. Additionally, the conductive dispersed phase may also include at least one carbon-based additive selected from a group consisting of CNT, graphene, and particulate carbon.

Additionally, according to an embodiment of the present invention, the plasma-resistant member may include a body and a coating layer surrounding the body, and the coating layer may include a matrix phase consisting of yttrium oxides and a conductive dispersed phase.

The yttrium oxide of the present invention may include yttria (Y₂O₃), or yttrium aluminum garnet (YAG). Also, the matrix phase may further include zirconia or alumina.

According to an embodiment of the present invention, the plasma-resistant member may include at least 5% by volume of the dispersed phase, and may also include 30% by volume or less of the dispersed phase. Preferably, the plasma-resistant member may include 10˜20% by volume of the dispersed phase.

The plasma-resistant member of the present invention may have a conductivity in the range of 10⁻²˜10⁻² S/cm.

In order to achieve another technical task, the present invention provides a method of producing a plasma-resistant member including an yttrium compound, which includes providing a powder mixture of an yttrium oxide and a conductive material, molding the powder mixture to produce a molded product, and sintering the molded product under a nitrogen atmosphere.

According to an embodiment of the present invention, the conductive material may include a carbide or nitride of at least one metal selected from a group consisting of Ti, Zr and Hf.

The sintering in an embodiment of the present invention may be performed under atmospheric pressure or under vacuum, or by spark plasma sintering (SPS).

Also, according to an embodiment of the present invention, the present invention provides a method of producing a plasma-resistant member including a yttrium compound, which includes molding a powder mixture of an yttrium oxide and a carbide or nitride of at least one metal selected from a group consisting of Ti, Zr and Hf to produce a molded product, calcining the molded product, and sintering the molded product under a nitrogen atmosphere.

According to the present invention, the present invention may provide an yttria-based plasma-resistant member. The plasma-resistant member of the present invention may be applied to various components of semiconductor processing equipment.

For example, an yttria composite according to the present invention may provide a semiconductor-grade conductivity, and thus it may be used as a plasma-resistant member requiring conductivity like a focus ring. Additionally, according to the present invention, it is possible to produce a semiconductor-grade yttria composite on the order of 10⁻⁴ S/cm, compared to a monolithic yttria, which is a nonconductor on the order of 10⁻¹⁴ S/cm. Of course, it is possible to further improve or control conductivity according to the content of conductive additives.

According to the present invention, densification may be achieved by ordinary sintering under atmospheric pressure (nitrogen 1 atmosphere), instead of the press sintering of the plasma-resistant member.

Additionally, the plasma-resistant member according to the present invention may have higher strength than monolithic Y₂O₃, and this may be helpful in solving the slow crack growth problem, which is one of the defects of the plasma-resistant Y₂O₃ material that needs to be supplemented.

### BRIEF DESCRIPTION OF DRAWINGS

FIG. 1 is a view illustrating an exemplary sintering schedule according to the present invention;

FIG. 2 is a graph illustrating a measurement of particle size distribution after milling according to an embodiment of the present invention;

FIG. 3 is a graph illustrating a measurement result of relative density, change in weight and shrinkage of a sintered body after vacuum sintering of calcined powder (Cal) and non-calcined powder (NC);

FIG. 4 is a graph illustrating a result of XRD analysis before and after calcination of powder mixture;

FIG. 5 is a graph illustrating a result of XRD analysis after sintering of calcination powder under nitrogen atmospheric pressure;

FIG. 6 is a graph illustrating a measurement result of conductivity of sintered body under nitrogen atmospheric pressure according to an embodiment of the present invention;

FIG. 7 (a-e) is a photograph taken by an electron microscope of sintered body under nitrogen atmospheric pressure according to an embodiment of the present invention;

FIG. 8 is a graph illustrating a measurement result of particle size distribution after planetary milling of a specimen produced in an embodiment of the present invention;

FIG. 9 is a graph illustrating a relative density according to the molding pressure of a specimen produced according to an embodiment of the present invention;

FIG. 10 is a graph illustrating a sintering shrinkage according to the molding pressure according to an embodiment of the present invention;

FIG. 11 is a graph illustrating a measurement result of conductivity of a specimen produced according to an embodiment of the present invention;

FIG. 12 is a graph illustrating a measurement result of biaxial strength of a specimen produced according to an embodiment of the present invention;

FIG. 13 is a graph illustrating an exemplary sintering schedule of an embodiment of the present invention;

FIG. 14 is a graph illustrating a sintering shrinkage behavior according to the temperature of a specimen produced according to an embodiment of the present invention;

FIG. 15 is a graph illustrating a relative density of a sintered body after sintering according to an embodiment of the present invention;

FIG. 16 is a graph illustrating a measurement result of conductivity of a specimen produced according to an embodiment of the present invention;

FIG. 17 is a graph illustrating a measurement result of biaxial strength of a specimen produced according to an embodiment of the present invention; and

FIG. 18 (a-c) is a photograph taken by an electron microscope illustrating a fine structure of fracture of a specimen produced according to an embodiment of the present invention.

### DETAILED DESCRIPTION FOR CARRYING OUT THE INVENTION

Hereinafter, the present invention will be described by explaining preferable embodiments of the present invention.

The plasma-resistant member of the present invention includes an yttrium oxide and a conductive additive for improving conductivity of the yttrium oxide.

The plasma-resistant member of the present invention may be in a bulk form where a conductive phase is dispersed into an yttrium oxide matrix phase. Unlike this, the plasma-resistant member of the present invention may include a body made of a predetermined material and a coating surrounding the body. The coating may include the above-mentioned yttrium oxide matrix phase and conductive dispersed phase. The coating may be provided with various methods such as plasma spraying, etc.

The plasma-resistant member of the present invention may be used for focus rings, shower heads, etc. of semiconductor processing equipment. Of course, the plasma-resistant member of the present invention is not limited to the semiconductor producing equipment, and may be applied to various fields. For example, the plasma-resistant member of the present invention may be applied to antistatic rollers, etc. of display equipment.

The yttrium oxide constituting the plasma-resistant member of the present invention may be composed of pure yttria, or an oxide-type compound like yttrium aluminum garnet (YAG). Of course, the yttrium oxide may be a compound of yttria or YAG.

The yttrium oxide of the present invention may include zirconia, alumina, or a combination thereof as a sintering aid.

The conductive additive included in yttria is required to have high conductivity and stability to prevent etching under a fluorinated plasma atmosphere.

Table 1 below illustrates the electric resistance (Ωm) of major candidate materials of carbide-based and nitride-based conductive additives, and the melting point (° C.) of the fluoride thereof.

TABLE 1

| Material | Electric resistance (Ωm) | Melting point of fluoride (° C.) |
|---|---|---|
| Si | 10² | −90.2 |
| Y₂O₃ | 10¹² | 1150 |
| Al₂O₃ | 10¹⁴ | 2250 |
| TiC, TiN | 10⁻⁷~10⁻⁶ | 284 |
| ZrC, ZrN | | 932 |
| HfC, HfN | | 970 |
| TaC | | 95 |
| WC | | 2 |

The conductive additive is expected to be stable for etching as the melting point of fluoride, which may be made by the reaction of conductive additive with fluorine, gets higher than the temperature during an etching process. When operating a cooling system of the processing equipment, the maximum temperature of the jig component is known to be 100° C. or below. Thus, TiC, TiN, ZrC, ZrN, HfC, HfN, etc. are determined to be a candidate group for effective additives. Carbide-based and nitride-based ceramics have a high binding with the yttria matrix phase, and may also have an improved strength compared to monolithic yttria, when expressing particle growth inhibition function by Zener effect.

Meanwhile, as another embodiment, additives such as CNT, graphene, particulate carbon, etc. may be used in the present invention, and carbon-containing additives may contribute to improvement of conductivity.

### Example 1

ZrO₂ (<100 nm) is mixed with Y₂O₃ (d₅₀=1.2 μm) as a sintering aid and TiC (<100 nm) is mixed as a conductive additive.

A basic composition of the mixing ratio is Y₂O₃+1 at % ZrO₂, and 10 vol % and 20 vol % of TiC are added to this composition. According to the percolation theory, it is known that 10 vol % is a boundary value and 20 vol % is a stability value for granting conductivity to a nonconductor. However, in the embodiment of the present invention, the content of the conductive additive may vary depending on the type of additive. For example, the content of the additive may be controlled so that the content of the dispersed phase is at least 5% by volume or 30% by volume or less.

Meanwhile, in order to observe a dispersion effect, a composition added with PEG is prepared. Table 2 below shows the mixing ratio of each specimen in the embodiment of the present invention.

TABLE 2

| specimen | Y2O3 (g) | ZrO2 (g) | TiC (g) | PEG (g) |
|---|---|---|---|---|
| 10%4h | 89.30 | 0.98 | 9.72 | — |
| 10%4hP | 89.30 | 0.98 | 9.72 | 1.0 |
| 20%4h | 79.61 | 0.88 | 19.51 | — |
| 20%4hP | 79.61 | 0.88 | 19.51 | 1.0 |
| 20%24h | 79.61 | 0.88 | 19.51 | — |
| 20%24hP | 79.61 | 0.88 | 19.51 | 1.0 |

For comparison, Y₂O₃+1 at % ZrO₂ not added with TiC is prepared as well.

A starting material is mixed according to the composition in Table 2 and the mixture is subject to planetary milling (ZrO₂ ball and jar, anhydrous ethanol, 100 rpm) for 4-24 hours, and then dried in a rotary evaporator at 70° C.

The dried powder is calcined at 700° C. for 1 hour. In order to observe the effect of calcination, in the case of the 20%4 h specimen and 20%4 hP specimen, a powder omitted with the calcination process is prepared.

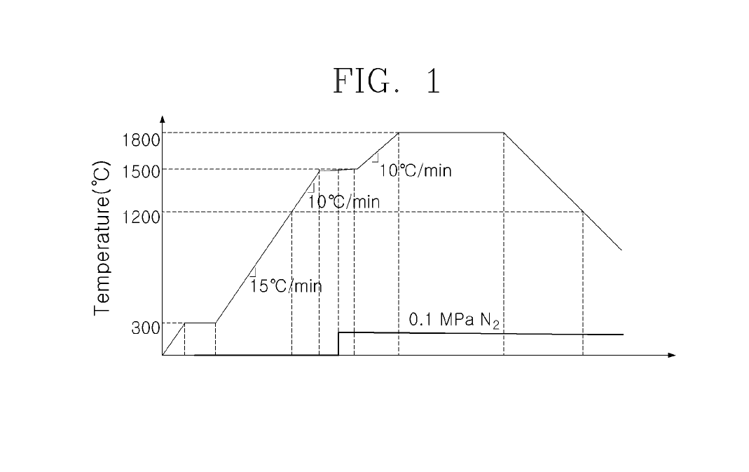

Furthermore, after isostatic pressing by using a mold with a diameter of 15 mm, Y₂O₃ atmospheric powder is filled in a carbon crucible, and a specimen is buried inside the atmospheric powder to perform vacuum sintering and nitrogen 1 pressure atmospheric pressure sintering. The sintering temperature is 1800° C., and the sintering is maintained for 3 hours. FIG. 1 is a view illustrating an exemplary sintering schedule of the present invention.

The fine structure of the sintered specimen is observed through a scanning electron microscope, and XRD phase analysis, conductivity, and biaxial strength are measured.

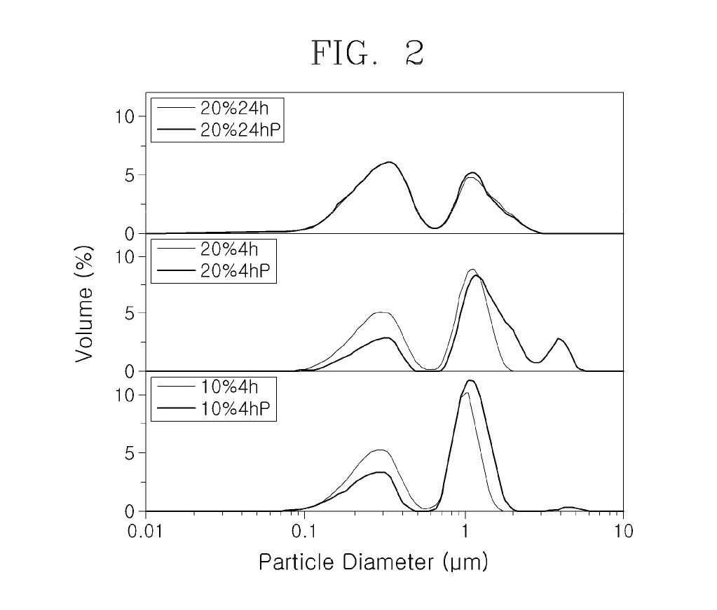

FIG. 2 is a graph illustrating a measurement of particle size distribution after milling.

From FIG. 2, it may be known that all compositions show bimodal distribution. In the case of 24 hours of milling, there are many particles that belong to a small particle size distribution (mainly, TiC), whereas in the case of 4 hours of milling, there are many particles that belong to a big particle size distribution (mainly, Y₂O₃). The addition of PEG hardly affects particle size distribution.

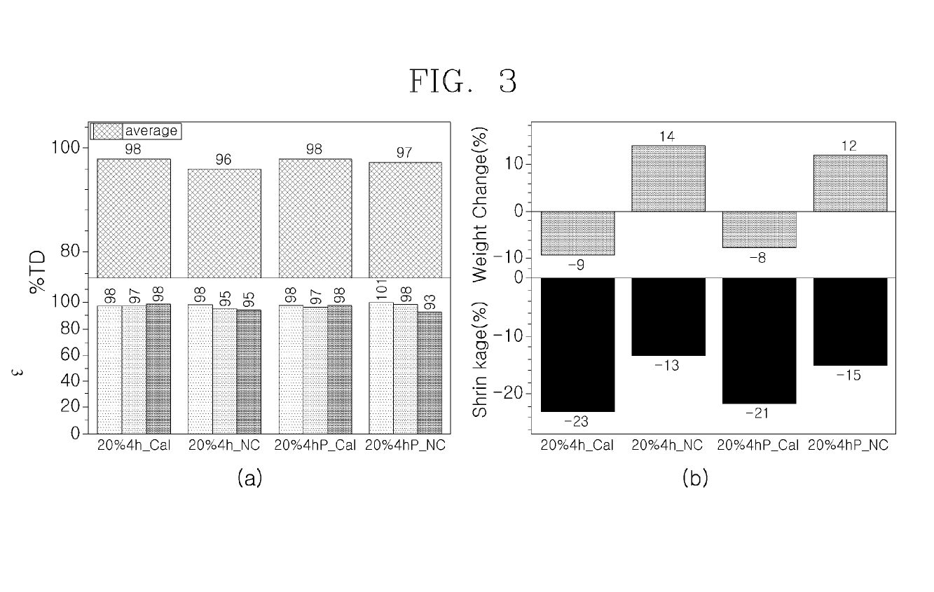

FIG. 3 (a) is a graph illustrating a measurement result of relative density, change in weight and shrinkage of sintered body after vacuum sintering of calcined powder (Cal) and non-calcined powder (NC).

It may be known that the relative density of the sintered body is 96-98%, which is similar to each other regardless of whether the powder is calcined, but the change in weight and shrinkage cause a big difference depending on whether the powder is calcined. Calcined powder shows a decrease in weight by 8-9% and a great shrinkage by 21-23%, whereas non-calcined powder shows an increase in weight by 12-14% and a small shrinkage by 13-15%. The decrease in weight during high-temperature sintering is normal, but the increase in weight is not. Thus, non-calcined powder is not considered to be suitable for the present invention.

When going through calcination, some TiC is oxidized into TiO₂. When applying sintering under atmospheric pressure nitrogen atmosphere, TiO₂ is nitrified into TiN. Thus, it is expected that there would be no decrease in conductivity by TiO₂.

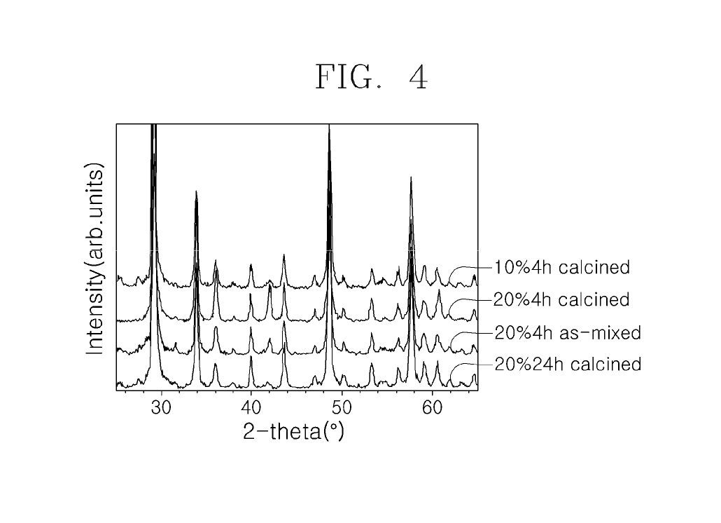

FIG. 4 is a graph illustrating a result of XRD analysis before and after calcination of powder mixture.

It may be confirmed from FIG. 4 that some of the TiC added is oxidized into TiO₂. The sintering under nitrogen atmosphere nitrifies TiO₂ oxidized during calcination into TiN to contribute to improvement of conductivity.

Meanwhile, as a result of sintering the powder calcined under nitrogen atmospheric pressure, regardless of the composition, densification sintering with a level of 97-99% of relative density is possible. Table 3 below shows the relative density after the sintering under nitrogen atmospheric pressure.

TABLE 3

| | | |
|---|---|---|
| specimen | % TD | Average |

| | | | |
|---|---|---|---|
| 10%4h | 96.56 | 97.91 | 97.23 |
| 10%4hP | 98.31 | 99.20 | 98.77 |
| 20%4h | 99.16 | 98.63 | 98.90 |
| 20%4hP | 98.54 | 98.54 | 98.54 |
| 20%24h | 98.75 | 98.75 | 98.75 |
| 20%24hP | 98.82 | 98.46 | 98.64 |

Although it was expected that it would be difficult to perform densification with sintering under atmospheric pressure alone because of the Zener effect impeding a grain-boundary migration by the addition of TiC, it was possible to manufacture a sintered body with high density. Additionally, it may be known that the difference in sintering density resulting from the amount of TiC added and whether PEG is added is insignificant.

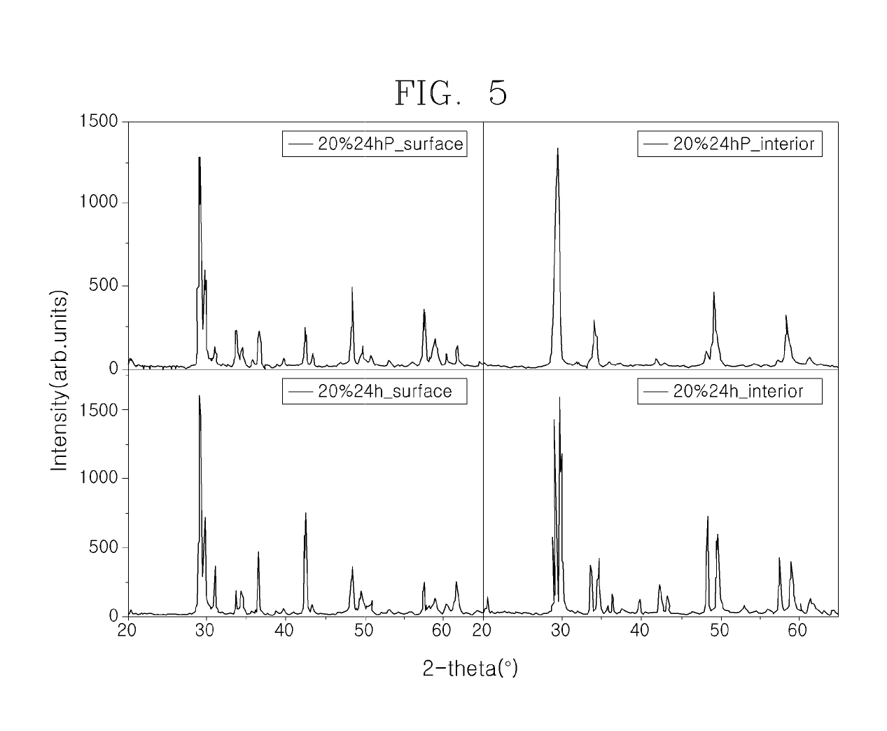

FIG. 5 is a graph illustrating a result of XRD analysis after sintering of calcination powder under nitrogen atmospheric pressure.

As a result of phase analysis, it may be confirmed that TiN is detected, in addition to TiC. That is, it may be known that TiO₂ produced by the oxidation reaction during the calcination process is nitrified during the sintering under nitrogen atmosphere to form TiN. Additionally, TiC and TiN all have high conductivity, so the above-mentioned production process may improve conductivity of the sintered body.

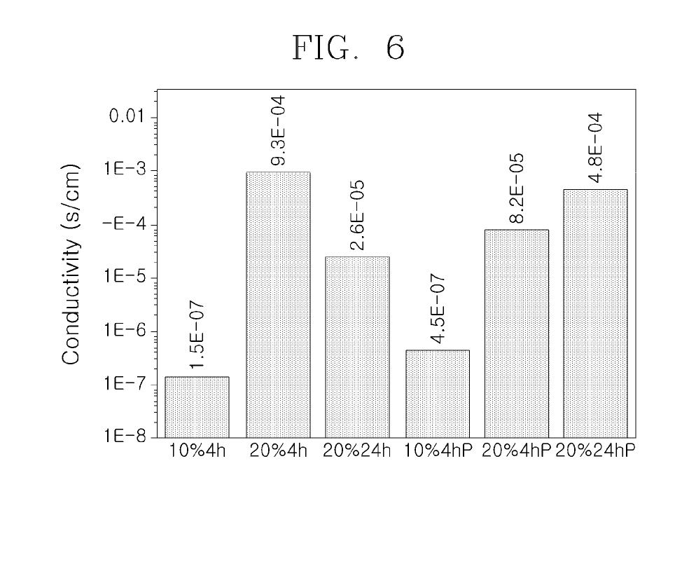

FIG. 6 is a graph illustrating a measurement result of conductivity of sintered body under nitrogen atmospheric pressure.

Referring to FIG. 6, a sintered body specimen has a conductivity in the range of 1.5*10⁻⁷˜9.3*10⁻⁴ S/cm. Compared to the conductivity of monolithic yttria of 1.0*10⁻¹⁴ S/cm, it may be known that the sintered body specimen has semiconductor-grade conductivity.

Meanwhile, when the amount of TiC added increases, the conductivity value also increases. When the amount of TiC added is 10 vol % and 20 vol %, the conductivity is measured to be on the order of 10⁻⁷ order and 10⁻⁴, respectively. Thus, when the TiC content increases to be at least 20 vol %, it is expected that conductivity would increase in proportional thereto.

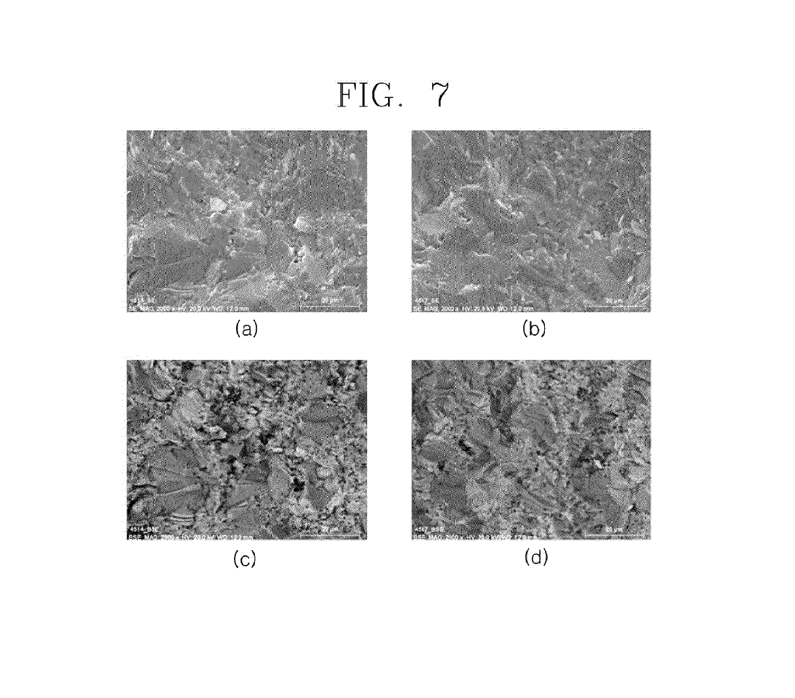

FIG. 7 (a-e) is a photograph taken by an electron microscope of Y2O3-TiC sintered body produced according to an embodiment of the present invention.

FIG. 7 illustrates SE mode photographs (a and b) which are mainly topography, and BSE mode photographs (c and d) reflecting atom number contrast, simultaneously.

The gray part in the BSE mode photograph indicates Y₂O₃ whose atom number is high, and the black part indicates Tic whose atom number is low. That is, it may be known that conductive TiC of fine particles is uniformly dispersed in the non-conductive Y₂O₃ matrix of the assembly.

The biaxial strength of the Y₂O₃—TiC sintered body produced is measured. The measurement is conducted by piston-on-3ball test method.

As a result of the measurement, the composition added with 20 vol % of TiC has the highest strength, and the maximum strength is measured to be 193 MPa. Considering that the strength of monolithic yttria is 163 MPa, it may be known that by the dispersion of TiC, the conductivity increases and the strength increases as well. This shows that an excellent composite may be produced, compared to the decrease in strength due to the carbon-based additive.

### Example 2

In the same manner as Example 1, ZrO₂ (<100 nm) is mixed with Y₂O₃ (d₅₀=1.2 μm) as a sintering aid, and TiC or TiN(<100 nm) is mixed as a conductive additive. The basic composition is Y2O3+1 at % ZrO2, and 10 vol %, 20 vol % and 30 vol % of TiC or TiN are added to this composition, respectively, but PEG is not added. For comparison of strength, a composition not added with TiC (Y2O3+1 at % ZrO2) is also prepared. Table 4 shows the mixing composition of Example 2. Specimen number 10C in Table 4 indicates a specimen where 10 vol % of TiC is added, 20C indicates a specimen where 20 vol % of TiC is added, and 30C indicates a specimen where 30 vol % of TiC is added. Specimen numbers 10N, 20N and 30N, respectively, indicate each TiN and the content of TnN added.

TABLE 4

| specimen | Y2O3 (g) | ZrO2 (g) | TiC (g) | TiN (g) |
|---|---|---|---|---|
| ref | 98.91 | 1.09 | — | — |
| 10C | 89.29 | 0.98 | 9.72 | — |
| 20C | 79.61 | 0.88 | 19.51 | — |
| 30C | 69.88 | 0.77 | 29.35 | — |
| 10N | 88.80 | 0.98 | — | 10.22 |
| 20N | 78.74 | 0.87 | — | 20.39 |
| 30N | 68.73 | 0.76 | — | 30.51 |

A starting material is mixed according to the composition in Table 4 and the mixture is subject to planetary milling (ZrO₂ ball and jar, anhydrous ethanol, 100 rpm) for 4 hours, and then dried in a rotary evaporator at 70° C.

In order to observe the effect of calcination, powder not calcined, powder calcined at an air atmosphere of 700° C., and powder calcined at a vacuum atmosphere of 700° C. are prepared. Then, after isostatic pressing by using a mold with a diameter of 15 mm, Y₂O₃ atmospheric powder is filled in a carbon crucible, and a specimen is buried inside the atmospheric powder to perform vacuum sintering. The sintering process follows the sintering schedule illustrated in FIG. 1 except that it is performed under vacuum atmosphere.

The conductivity and biaxial strength of the sintered specimen are measured.

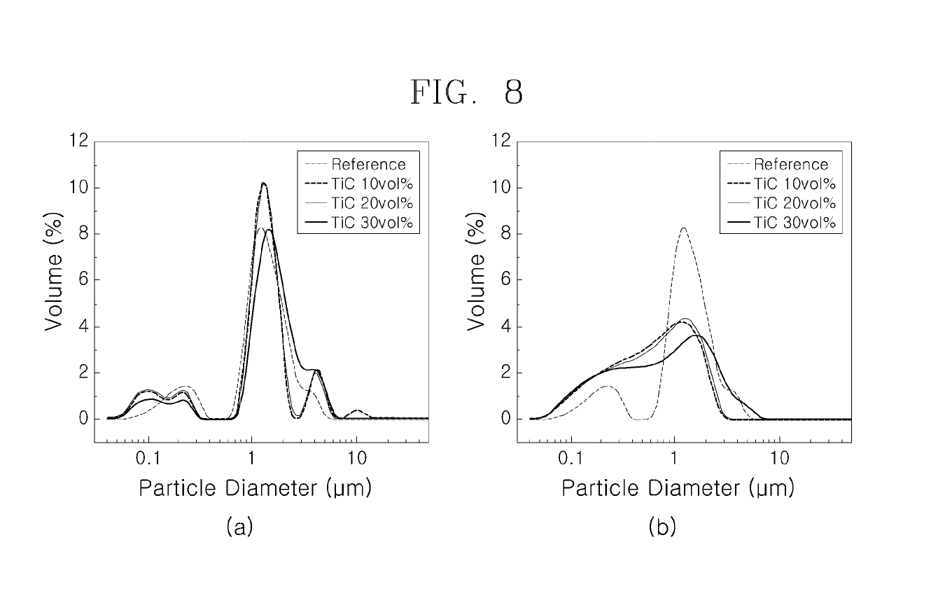

FIG. 8 is a graph illustrating a measurement result of particle size distribution after planetary milling of a specimen produced according to the present embodiment. FIG. 8 (a) indicates a specimen including TiC as additive, and FIG. 8 (b) indicates a specimen added with TiN as additive.

In case of the specimen added with TiC, it may be known that even after planetary milling, there are many coagulated particles with the size of at least 1 μm, and the particles show bimodal distribution. In comparison, in case of the specimen added with TiN, a relatively greater amount of particles are distributed in the sub-micro region through milling, so they have a particle size distribution ranging from 0.1 to 5 μm.

Meanwhile, although it is not illustrated, upon reviewing the effect of calcination on the relative density of sintered body, the composition added with TiC shows a high density during calcination in the air, and the composition added with TiN shows a high density during non-calcination or calculation in vacuum.

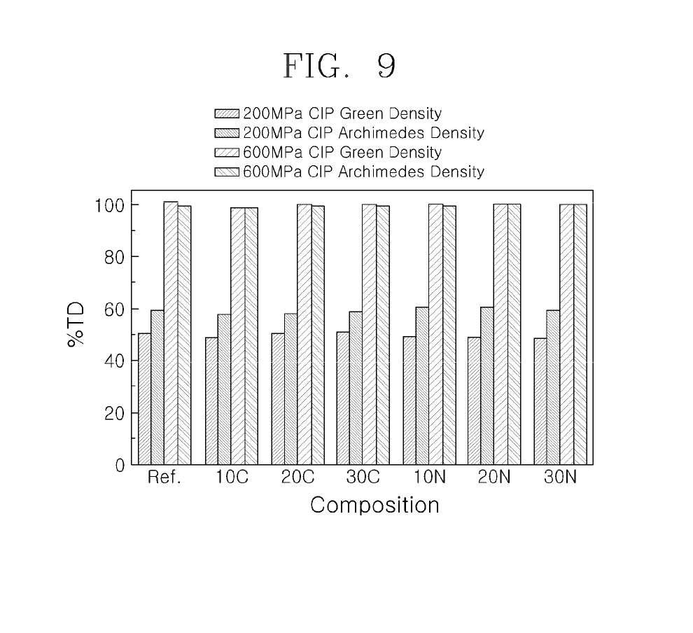

FIG. 9 is a graph illustrating a relative density according to the molding pressure of a specimen produced according to an embodiment of the present invention. For reference, a green density right after molding is also illustrated. Here, the specimen added with TiC (10C, 20C and 30C) indicate specimen calcined in the air, and the specimen added with TiN indicate the specimen calcined in vacuum. For comparison, a reference composition (Ref) not calcined is also illustrated.

Referring to FIG. 9, under molding pressures of 200 MPa and 600 MPa, the relative density of the molded product is about 50% and 60%, respectively, which means that as the molding pressure gets higher, the relative density becomes higher. However, regardless of the molding pressure, the density of sintered body after vacuum sintering shows that densification sintering of at least 99% is possible.

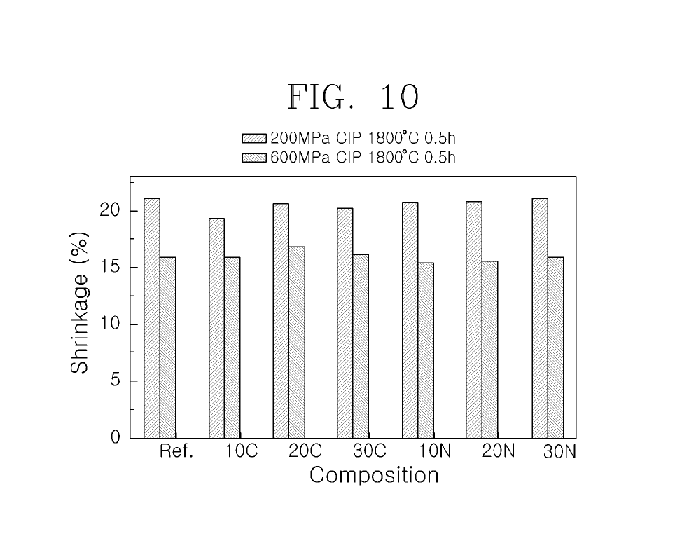

FIG. 10 is a graph illustrating a sintering shrinkage according to the molding pressure.

Referring to FIG. 10, it may be known that low-pressure molding has greater shrinkage than high-pressure molding. Meanwhile, the specimen produced by high-pressure molding could be densified at a lower temperature. In this case, the strength may be improved due to the particle growth inhibition effect by low-temperature sintering.

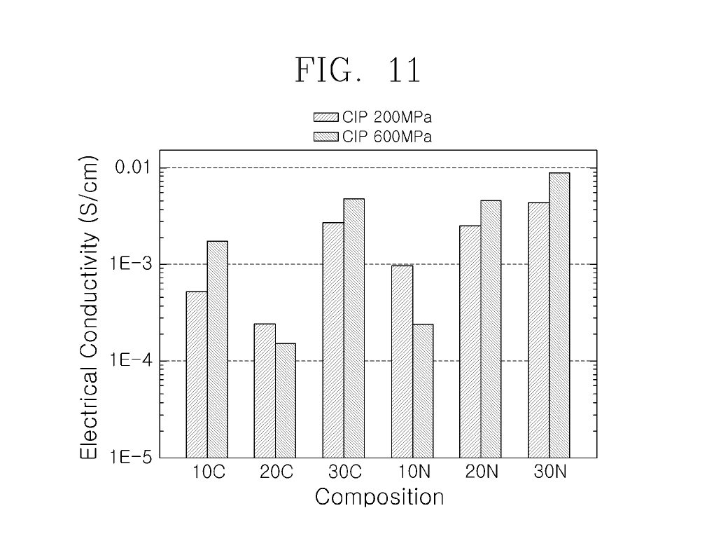

FIG. 11 is a graph illustrating a measurement result of conductivity according to an embodiment of the present invention.

From FIG. 11, it may be known that it is possible to produce a semiconductor-grade yttria composite on the order of 10⁻⁴-10⁻² S/cm, compared to monolithic yttria (on the order of 10⁻¹⁴ S/cm) which is a nonconductor. The CIP pressure is less likely to affect conductivity. As the amount of conductive additive increases, the conductivity tends to increase as well.

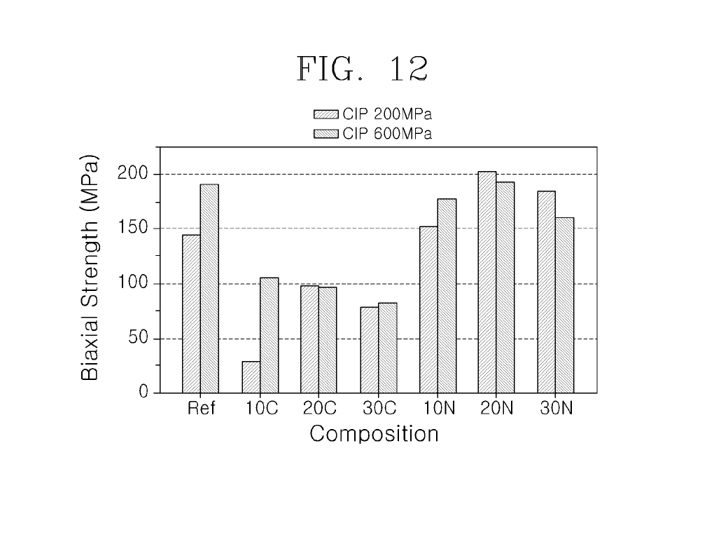

FIG. 12 is a graph illustrating a measurement result of biaxial strength according to an embodiment of the present invention.

Referring to FIG. 12, the specimen added with TiC has a remarkably decreased strength compared to the reference, whereas the specimen added with TiN shows similar or improved strength compared to the reference. This might be relevant to the particle size distribution illustrated in FIG. 6. TiC relatively has more aggregates than TiN, which results in the decrease in strength. When the CIP pressure increases from 200 MPa to 600 MPa, the strength of reference specimen is improved by at least 30%. However, in case of the specimen added with TiC and TiN, it may be known that the effect of the molding pressure on strength is insignificant.

### Example 3

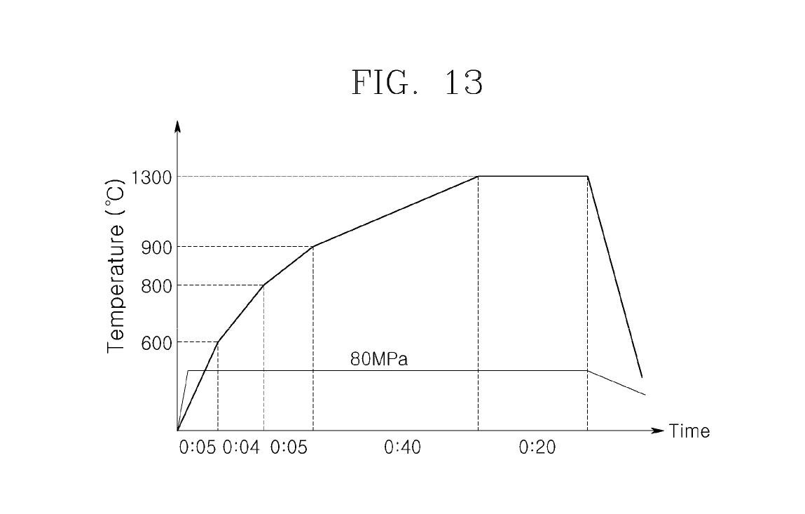

The raw powder in Table 4 is mixed, and the mixture is subject to milling, and then dried under the same condition as in Example 3. The calcination process is omitted, and spark plasma sintering (SPS) is performed at 1260° C. and 1300° C. for 20 minutes under the pressure of 80 MPa, by using the carbon mold of 20 mm. FIG. 13 illustrates an exemplary sintering schedule according to an embodiment of the present invention.

The conductivity and biaxial strength of sintered specimen are measured.

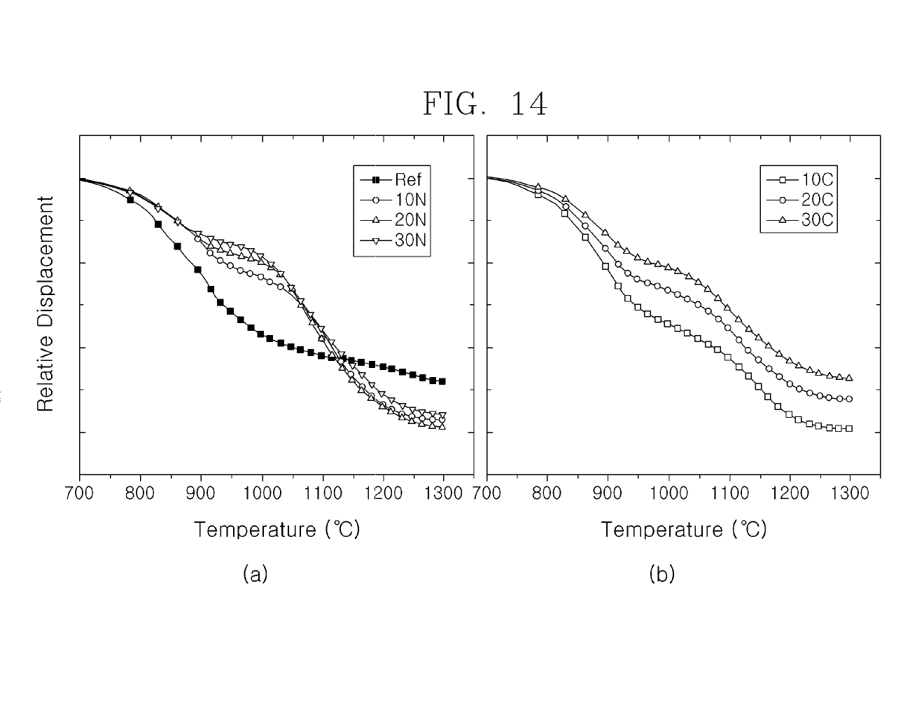

FIG. 14 is a graph illustrating a sintering shrinkage behavior according to the temperature of a specimen produced according to an embodiment of the present invention.

Referring to FIG. 14 (a), reference Y₂O₃ specimen (Ref) is rapidly shrunk in the beginning of sintering, but sintering is gradually performed from the middle. In case of the specimen added with TiN (10N, 20N and 30N), the first shrinkage and second shrinkage are clearly distinguishable. As the content of TiN increases, the initial sintering is performed relatively rapidly. However, it may be known that the specimen presents a similar final shrinkage, and their shrinkage termination temperature is around 1250° C. and 1300° C.

Meanwhile, as illustrated in FIG. 14 (b), in case of the specimen added with TiC 10C, 20C and 30C) as the content of TiC increases, the shrinkage speed and shrinkage all decrease.

From FIG. 14, it may be known that the sintering temperature per composition is about 1300° C. for the reference specimen and about 1260° C. for the specimen added with TiC. In case of the specimen added with TiN, the sintering temperature is 1260° C. for 10N and about 1280° C. for 20N and 30N.

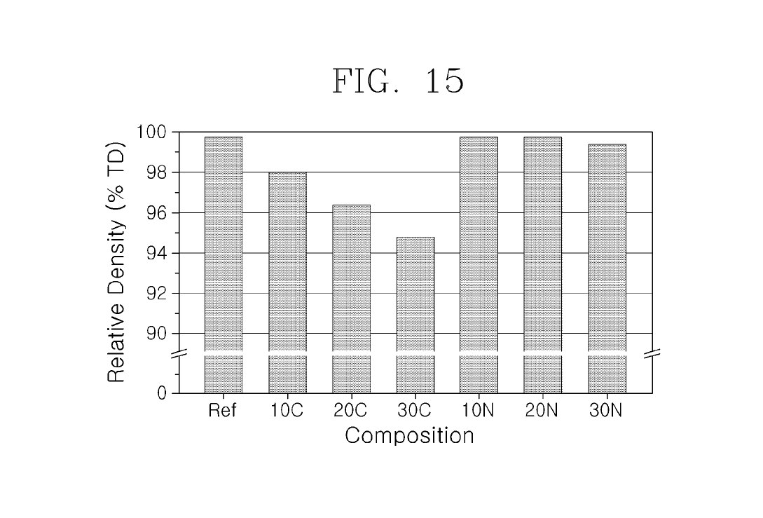

FIG. 15 is a graph summarizing a relative density of sintered body after sintering according to an embodiment of the present invention.

It may be known that the reference specimen and specimen added with TiN are densified by at least 99%. In comparison, the specimen added with TiC shows a low relative density of 98% or less, and the density decreases as the content of TiC increases. Upon comparing the density with the shrinkage behavior in FIG. 13, both TiN and TiC have low shrinkage due to particle re-arrangement during the first shrinkage because of nano-sized particle. In case of the specimen added with TiN, densification is sufficiently performed during the second shrinkage section. However, the specimen added with TiC tends to inhibit sintering, so it is deemed that there is a difference in final density. Meanwhile, when the specimen added with TiC is sintered at a high temperature, the sintering density may increase.

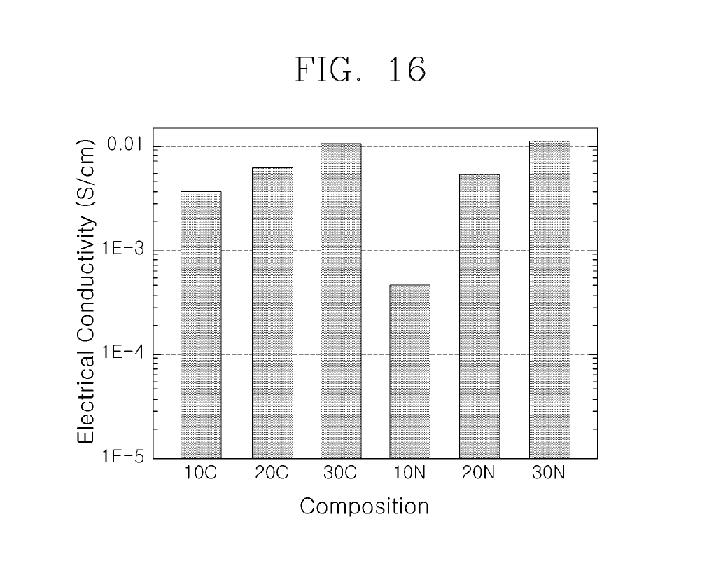

FIG. 16 is a graph illustrating a measurement result of conductivity of a specimen produced according to an embodiment of the present invention.

Referring to FIG. 16, the specimen added with TiC whose relative density is low, as well as the specimen added with TiN, has conductivity of 10⁻⁴-10⁻² S/cm. It may be known that even if the sintering density is slightly low, the percolation may be effectively achieved by the addition of TiC. Additionally, in the same manner as vacuum sintering mentioned above, as the content of conductive additive increases, the conductivity also increases.

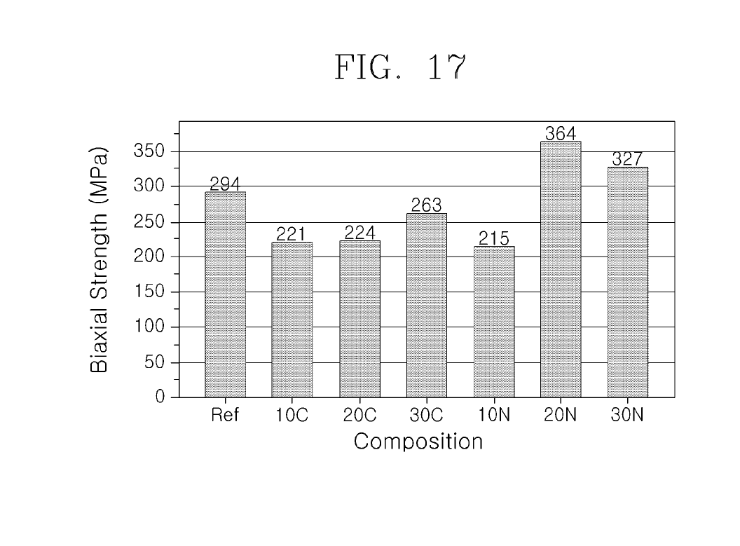

FIG. 17 is a graph illustrating a measurement result of biaxial strength of a specimen produced according to an embodiment of the present invention.

Referring to FIG. 17, the strength of reference specimen is 294 MPa during SPS, which is improved by 54% compared to the embodiment showing a maximum strength of 191 MPa during vacuum sintering. This results from the inhibition of particle growth by low-temperature press sintering.

Additionally, the specimen added with TiC shows decreased strength compared to the reference, and the specimen added with TiN shows improved strength compared to the reference specimen in terms of the content of some additives. Especially, in case of adding 20 vol % of TiN, the strength improved by about 24%, which is similar to the vacuum sintering case of the above-mentioned embodiment. Thus, in terms of strength, the optimal amount of TiN added is around 20 vol %.

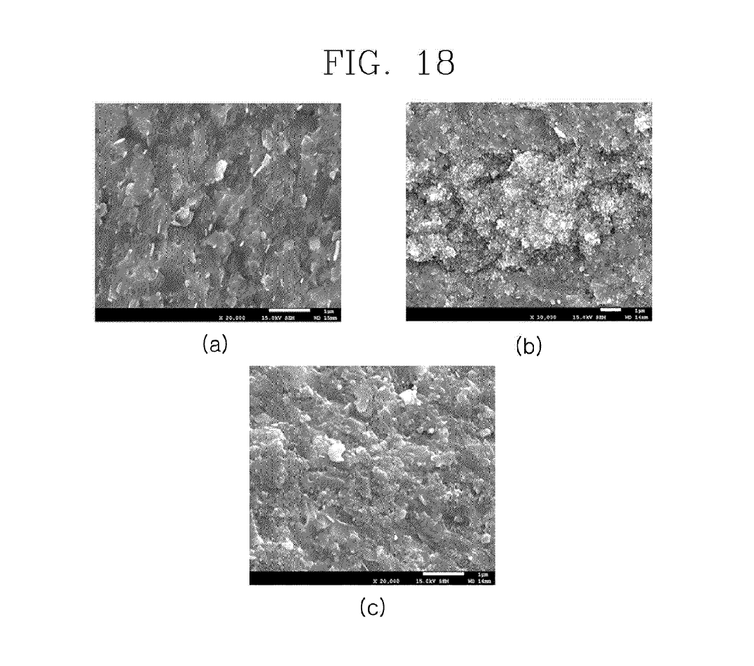

FIG. 18 (a-c) is a photograph taken by an electron microscope illustrating a fine structure of fracture of a specimen produced according to an embodiment of the present invention.

FIG. 18 (a) is a photograph of a fracture of Ref specimen with a particle size of 1 μm or less, which shows that the particle growth is less likely to be made. FIG. 18 (b) is a photograph of a fracture of specimen (20C) added with TiC, which shows that the nano-sized TiC is not uniformly dispersed, but is coagulated in some regions. As illustrated in FIG. 18 (c), in case of the specimen (20N) added with TiN, it may be known that the additive is uniformly distributed in Y₂O₃, which is matrix.

What is claimed is:

1. A plasma-resistant member comprising an yttrium compound, comprising:
a matrix phase consisting of yttrium oxides; and
a conductive dispersed phase.

2. The plasma-resistant member of claim 1, wherein the conductive dispersed phase comprises a carbide or nitride of at least one metal selected from a group consisting of Ti, Zr and Hf.

3. The plasma-resistant member of claim 1, wherein the conductive dispersed phase comprises at least one carbon-based additive selected from a group consisting of CNT, graphene and particulate carbon.

4. The plasma-resistant member of claim 1, comprising:
a body; and
a coating layer surrounding the body,
wherein the coating layer comprises a matrix phase consisting of yttrium oxides and a conductive dispersed phase.

5. The plasma-resistant member of claim 1, wherein the yttrium oxide comprises yttria (Y₂O₃).

6. The plasma-resistant member of claim 1, wherein the yttrium oxide comprises yttrium aluminum garnet (YAG).

7. The plasma-resistant member of claim 5, wherein the matrix phase further comprises zirconia or alumina.

8. The plasma-resistant member of claim 1, wherein the plasma-resistant member comprises at least 5% by volume of the dispersed phase.

9. The plasma-resistant member of claim 1, wherein plasma-resistant member comprises 30% by volume or less of the dispersed phase.

10. The plasma-resistant member of claim 1, wherein the plasma-resistant member has a conductivity in the range of 10⁻⁷˜10⁻² S/cm.

11. The plasma-resistant member of claim 1, wherein the plasma-resistant member has a relative density of at least 95%.

12. A method of producing a plasma-resistant member comprising an yttrium compound, comprising:
providing a powder mixture of an yttrium oxide and a conductive material;
molding the powder mixture to produce a molded product; and
sintering the molded product under a nitrogen atmosphere.

13. The method of claim 12, wherein the conductive material comprises a carbide or nitride of at least one metal selected from a group consisting of Ti, Zr and Hf.

14. The method of claim 12, wherein the sintering is performed under atmospheric pressure or vacuum.

15. The method of claim 12, wherein the sintering is performed at a temperature of 1700˜1900° C.

16. The method of claim 12, wherein the sintering is performed by spark plasma sintering (SPS).

17. A method of producing a plasma-resistant member comprising an yttrium compound, comprising:
molding a powder mixture of a yttrium oxide and a carbide or nitride of at least one metal selected from a group consisting of Ti, Zr and Hf to produce a molded product;
calcining the molded product; and
sintering the molded product under a nitrogen atmosphere.

18. The plasma-resistant member of claim 6, wherein the matrix phase further comprises zirconia or alumina.
